(19) United States
(12) Patent Application Publication
(10) Pub. No.: US 2007/0193047 A1
(43) Pub. Date: Aug. 23, 2007

(54) MOBILE TERMINAL WITH HORIZONTALITY DISPLAY FUNCTION

(75) Inventors: Kyoung Soo Chae, Kyungki-do (KR); Ghun Hahm, Seoul (KR); Hyun Joon Kim, Kyungki-do (KR); Sung Whan Cho, Kyungki-do (KR)

Correspondence Address: LOWE HAUPTMAN BERNER, LLP, 1700 DIAGONAL ROAD, SUITE 300, ALEXANDRIA, VA, 22314, US

(73) Assignee: SAMSUNG ELECTRO-MECHANICS CO., LTD., GYUNGGI-DO (KR)

(21) Appl. No.: 11/613,687

(22) Filed: Dec. 20, 2006

(30) Foreign Application Priority Data
Feb. 21, 2006 (KR) 10-2006-0016849

(51) Int. Cl. G01C 9/06

(52) U.S. Cl. 33/366.11

(57) ABSTRACT

A mobile terminal with a horizontality display function is provided. In the mobile terminal, a body plane is formed at one side of an exterior of a body of the mobile terminal, and an acceleration sensor is installed parallel to the body plane and detects an acceleration corresponding to a physical change with reference to a reference XY horizontal plane. A memory stores preset sensor offset value and sensor sensitivity value of the acceleration sensor, and a controller calculates inclination angles at which the body plane is inclined with respect to the reference XY horizontal plane, using the sensor offset value and the sensor sensitivity value stored in the memory. A horizontality display unit displays as an image a current horizontality detected by the controller on the basis of the calculated inclination angles with respect to the reference XY horizontal plane.

### RELATED APPLICATION

The present application is based on, and claims priority from, Korean Application Number 2006-16849, filed Feb. 21, 2006, the disclosure of which is hereby incorporated by reference herein in its entirety.

### BACKGROUND OF THE INVENTION

1. Field of the Invention

The present invention relates to a mobile terminal with a horizontality display function, and particularly, to a mobile terminal with a horizontality display function, such as a cellular phone, a master production scheduler (MPS) and a personal digital assistant (PDA), which is implemented to measure and display the horizontality thereof so that a user can conveniently and easily ascertain the horizontality of a product in everyday life.

2. Description of the Related Art

In general, it is very important to maintain the horizontality of electronic products (i.e., a washer and a projector) and furniture in order to increase lifespan thereof. When a device that must maintain the horizontality is initially installed, a seller installs the device, ascertaining the horizontality.

A horizontality indicator of the washer will now be described with reference to FIG. 1.

FIG. 1 is a view for describing a horizontality indicator of a conventional washer. Referring to FIG. 1, a user ascertains the horizontality of a conventional washer 10, using a horizontality indicator 11 installed on an outer side of the washer 10. Here, the horizontality indicator 11 uses waterdrops or bubbles in the water.

In the case where the horizontality indicator 11 is an instrument that indicates the horizontality by a position of a waterdrop, a waterdrop within the horizontality indicator 11 is placed at a certain location according to the horizontality of the washer 10.

However, the conventional horizontality indicator is problematic in that since a user determines the horizontality by observing the indicator with the naked eye, accuracy of the determination is lowered and even objective accuracy cannot be ensured.

Also, if a product does not have a horizontality indicator, a separate horizontality indicator must be inconveniently used. Thus, the user cannot easily measure and ascertain the horizontality in everyday life.

### SUMMARY OF THE INVENTION

Accordingly, the present invention is directed to a mobile terminal with a horizontality display function that substantially obviates one or more problems due to limitations and disadvantages of the related art.

An object of the present invention is to provide a mobile terminal with a horizontality display function, such as a cellular phone, a master production scheduler (MPS) and a personal digital assistant (PDA), which is implemented to measure and display the horizontality thereof so that a user can conveniently and easily ascertain the horizontality of a product in everyday life.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a mobile terminal includes: a body plane formed at one side of an exterior of a body of the mobile terminal; an acceleration sensor installed parallel to the body plane, and detecting an acceleration corresponding to a physical change with reference to a reference XY horizontal plane; a memory storing previously-set sensor offset value and sensor sensitivity value of the acceleration sensor; a controller calculating inclination angles at which the body plane is inclined with respect to the reference XY horizontal plane, using the sensor offset value and the sensor sensitivity value stored in the memory; and a horizontality display unit displaying as an image a current horizontality detected by the controller on the basis of the calculated inclination angles with respect to the reference XY horizontal plane.

The horizontality display unit may output the current horizontality as inclination information with respect to XY directions.

The horizontality display unit may display the inclination information with respect to the XY directions, using at least one of a letter, a number, a figure and a color. A horizontality notifying unit is further included, which outputs a specific sound to notify a user of the current horizontality detected by the controller on the basis of the calculated inclination angles with respect to the reference XY horizontal plane.

The horizontality notifying unit may output a first signal sound when the current horizontality is a perfect horizontality parallel to the reference XY horizontal plane, and output a second signal sound when the current horizontality is not the perfect horizontality, namely, when the body plane is inclined at a predetermined inclination angle to the reference XY horizontal plane.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view for describing a horizontality indicator of a conventional washer;

FIG. 2 is a block diagram of a mobile terminal having a horizontality display function according to the present invention;

FIG. 3 is a state diagram of an acceleration sensor and an outer plane of the mobile terminal of FIG. 2;

FIG. 4 is a flowchart of a horizontality display operation of the mobile terminal of FIG. 2; and

FIG. 5 is a view showing an application example of the mobile terminal according to the present invention.

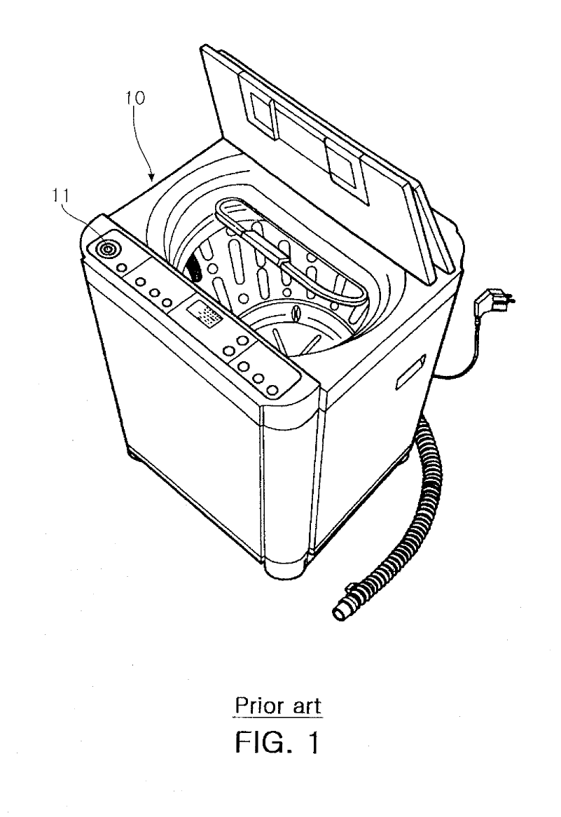

### DETAILED DESCRIPTION OF THE INVENTION

Reference will now be made in detail to the preferred embodiments of the present invention, examples of which are illustrated in the accompanying drawings.

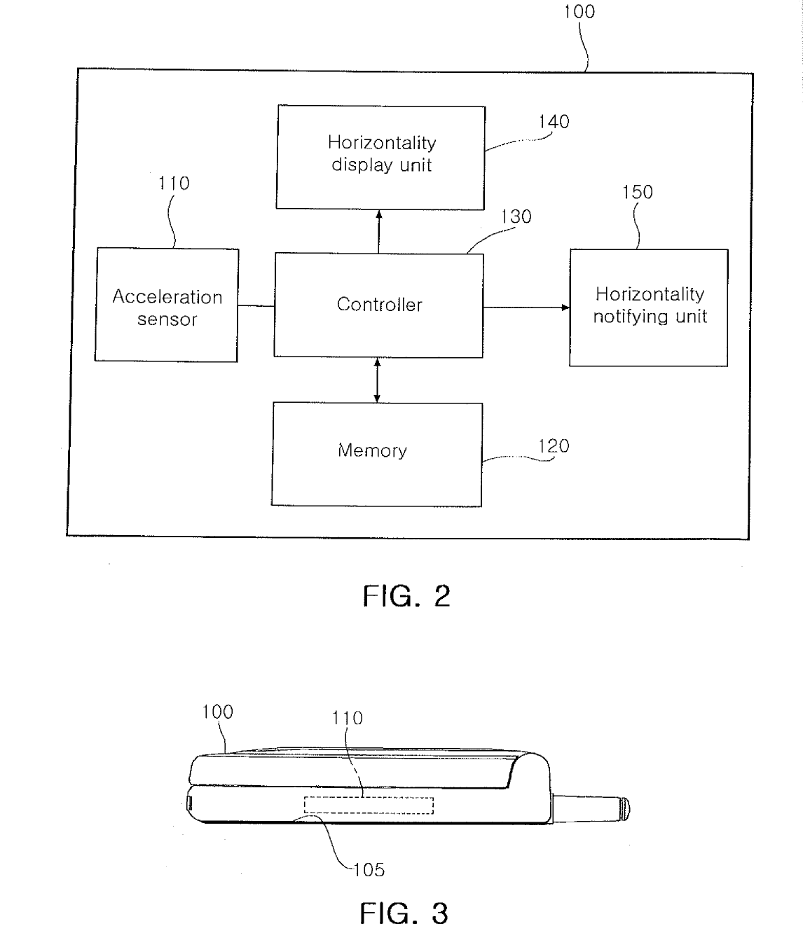

FIG. 2 is a block diagram of a mobile terminal with a horizontality display function according to the present invention. FIG. 3 is a state diagram of an acceleration sensor and an outer plane of the mobile terminal of FIG. 2.

Referring to FIGS. 2 and 3, the mobile terminal with a horizontality display function according to the present invention includes a body plane 105 formed at one side of an exterior of a terminal body; an acceleration sensor 110 installed parallel to the body plane 105, and detecting an acceleration corresponding to a physical change with reference to a reference XY horizontal plane; a memory 120 storing preset sensor offset value and sensor sensitivity value of the acceleration sensor 110; a controller 130 calculating inclination angles (θ) at which the body plane 105 is inclined with respect to the reference XY horizontal plane by using the sensor offset value and the sensor sensitivity value stored in the memory 120; and a horizontality display unit 140 displaying as an image the current horizontality detected by the controller 130 on the basis of the calculated inclination angle (θ) with respect to the reference XY horizontal plane.

The horizontality display unit 140 may output the current horizontality as inclination information with respect to XY directions, using a display device of the mobile terminal.

In more detail, the horizontality display unit 140 may display the inclination information with respect the XY directions, using at least one of a letter, a number, a figure and a color.

Also, the mobile terminal may further include a horizontality notifying unit 150 that outputs a specific sound to notify a user of the current horizontality detected by the controller 130 on the basis of the calculated inclination angles (0) with respect to the reference XY horizontal plane.

The horizontality notifying unit 150 outputs a first signal sound when the current horizontality is the perfect horizontality parallel to the reference XY horizontal planer and outputs a second signal sound different from the first signal sound when the body plane 105 is inclined at a certain inclination angle to the reference XY horizontal plane.

Referring to FIG. 3, the mobile terminal 110 includes the body plane 105 formed at one side of the exterior of the body of the mobile terminal 100. The body plane 105 can maintain a parallel state to the acceleration sensor 110. Here, the acceleration sensor 110 is installed parallel to the body plane 105, so that it can accurately detect an acceleration corresponding to a physical change with reference to the reference XY horizontal plane.

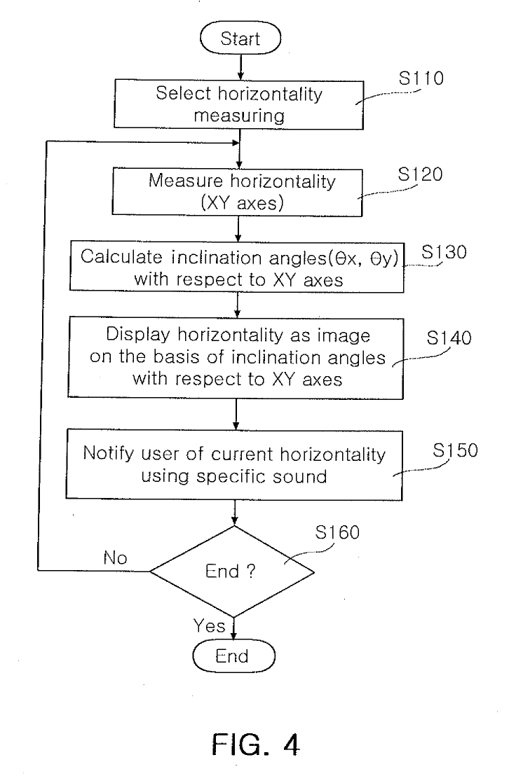

FIG. 4 is a flowchart of a horizontality display operation of the mobile terminal of FIG. 2.

In FIG. 4, the step S110 is to select horizontality measurement of the mobile terminal, the step S120 is to measure the horizontality, and the step S130 is to calculate inclination angles (θx, θy) with respect to the XY axes. The step S140 is to display as an image as an image the horizontality according to the inclination angles with reference to the x and y axes, and the step S150 is to notify a user of the current horizontality using a specific sound.

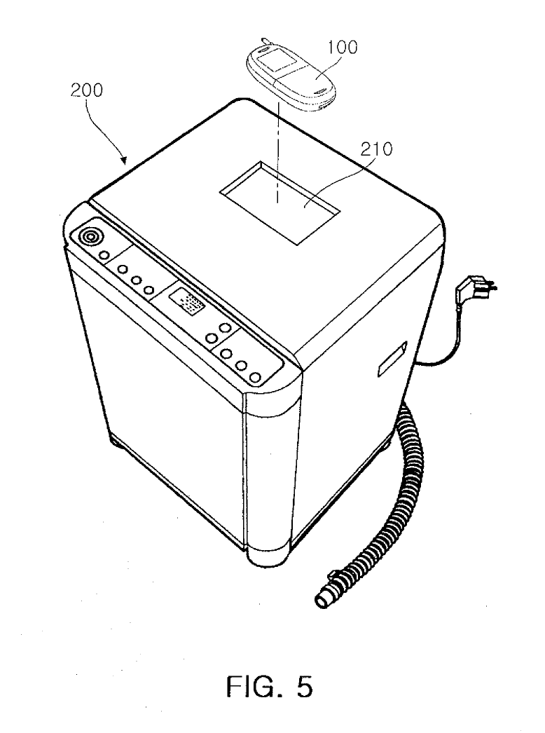

FIG. 5 is a view showing an application example of the mobile terminal according to the present invention. In FIG. 5, reference numeral 200 denotes a washer, 210 denotes a horizontality-measuring-unit receiving part placed on the same plane as the reference XY horizontal plane when the washer 200 is in the perfect horizontality. The mobile terminal according to the present invention is placed in the horizontality-measuring-unit receiving part 210, and measures the horizontality of the washer 200.

Operations and effects of the present invention will now be described in detail with reference to accompanying drawings.

Referring to FIGS. 2 through 5, the horizontality measuring and displaying of the mobile terminal according to the present invention will now be described.

Referring to FIGS. 2 and 3, the mobile terminal 100 according to the present invention includes the body plane 105, and the acceleration sensor 110. Here, the body plane 105 is formed at one side of the exterior of the terminal body, and the acceleration sensor 110 is installed parallel to the body plane 105 to detect an acceleration corresponding to a physical change with reference to the reference XY horizontal plane. By such a configuration, the horizontality of the mobile terminal can be accurately measured.

The memory 120 within the mobile terminal 110 according to the present invention stores preset sensor offset value and sensor sensitivity value of the acceleration sensor 110.

As shown in FIG. 4, the mobile terminal 100 according to the present invention performs measuring and displaying of the horizontality.

Referring to FIGS. 2 through 4, a user selects measuring of the horizontality of the mobile terminal 100 according to the present invention (S110). The selection of the horizontality measuring may be made through a key input unit of the mobile terminal 100. Here, the acceleration sensor 110 of the mobile terminal detects an acceleration corresponding to a physical change with reference to the reference XY horizontal plane, and outputs the detected acceleration to the controller 130 (S120).

The controller 130 calculates inclination angles (θ) at which the body plane 105 is inclined with respect to the reference XY horizontal plane, using the sensor offset and sensitivity values stored in the memory 120 according to Equation 1 below (S130). The controller 130 controls the horizontality display of the horizontality display unit 140 on the basis of the calculated inclination angles with reference to the XY axes.

Inclination angle (θ) cos⁻¹ (sensor output-sensor output)/sensor sensitivity [Equation 1]

The horizontality display unit 140 displays as an image the current horizontality which is detected by the controller 130 on the basis of the inclination angles with respect to the reference XY horizontal plane (S140).

Briefly speaking, the horizontality display unit 140 outputs inclination information of the XY directions as the current horizontality, using a display device of the mobile terminal.

For example, when the X direction is a front and rear direction and the Y direction is a right and left direction, the inclination information with respect to the XY directions may be expressed by ‘10° to the front’ and ‘5° to the right’.

Also, the horizontality display unit 140 may display the inclination information with respect to the XY directions, using at least one of a letter, a number, a figure and a color.

Here, the inclination information with respect to the XY directions may be expressed not only by letters and numbers as mentioned above but also by figures and colors.

That is, the inclination information may be expressed in various manners. For example, specific figures such as arrows or triangles may be displayed toward an inclination direction. Also, a dark color may be used toward the inclination direction in a black and white display device, or red may be used toward the inclination direction in a color display device.

The controller 130 controls the horizontality notifying unit 150 to output a specific sound to notify the horizontality with respect to the reference XY horizontal plane depending on the calculated inclination angles.

The horizontality notifying unit 150 outputs a specific sound to notify the current horizontality detected by the controller 130 on the basis of the calculated inclination angles with respect to the reference XY horizontal plane (S150).

In more detail, the horizontality notifying unit 150 outputs a first signal sound when the current horizontality is the perfect horizontality parallel to the reference XY horizontal plane, and outputs a second signal sound when the body plane 105 is inclined at a certain inclination angle to the reference XY horizontal plane.

Referring to FIG. 5, the mobile terminal 100 according to the present invention operated as mentioned above is placed in the horizontality-measuring-unit receiving part 210 of the washer 200. Then, when the measuring of the horizontality is selected in the mobile terminal 100, the aforementioned operation is performed, and consequently, the horizontality of the washer is displayed through the display device of the mobile terminal.

By using the mobile terminal according to the present invention, a user may easily ascertain the horizontality at the time of installing a product that must maintain the horizontality.

According to the present invention, a horizontality display function is loaded on the mobile terminal, such as a cellular phone, a master production scheduler (MPS) and a personal digital assistant (PDA), so that the mobile terminal can measure and display the horizontality thereof. Accordingly, a user can conveniently and easily ascertain the horizontality of a product in everyday life.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A mobile terminal comprising:
a body plane formed at one side of an exterior of a body of the mobile terminal;
an acceleration sensor installed parallel to the body plane, and detecting an acceleration corresponding to a physical change with reference to a reference XY horizontal plane;
a memory storing preset sensor offset value and sensor sensitivity value of the acceleration sensor;
a controller calculating inclination angles at which the body plane is inclined with respect to the reference XY horizontal plane, using the sensor offset value and the sensor sensitivity value stored in the memory; and
a horizontality display unit displaying as an image a current horizontality detected by the controller on the basis of the calculated inclination angles with respect to the reference XY horizontal plane.

2. The mobile terminal of claim 1, wherein the horizontality display unit outputs the current horizontality as inclination information with respect to XY directions.

3. The mobile terminal of claim 1, wherein the horizontality display unit displays the inclination information with respect to the XY directions, using at least one of a letter, a number, a figure and a color.

4. The mobile terminal of claim 1, further comprising: a horizontality notifying unit outputting a specific sound to notify a user of the current horizontality detected by the controller on the basis of the calculated inclination angles with respect to the reference XY horizontal plane.

5. The mobile terminal of claim 4, wherein the horizontality notifying unit outputs a first signal sound when the current horizontality is a perfect horizontality parallel to the reference XY horizontal plane, and outputs a second signal sound when the current horizontality is not the perfect horizontality, namely, when the body plane is inclined at a predetermined inclination angle to the reference XY horizontal plane.
